(19) United States
(12) Patent Application Publication
(10) Pub. No.: US 2015/0037456 A1
(43) Pub. Date: Feb. 5, 2015

(54) SYSTEM AND METHOD FOR DELIVERING HEALTH-PROMOTING SUBSTANCES INTO A HUMAN BODY

(71) Applicant: Anatoly Derin, Hallandale Beach, FL (US)

(72) Inventor: Anatoly Derin, Hallandale Beach, FL (US)

(21) Appl. No.: 14/449,203

(22) Filed: Aug. 1, 2014

Related U.S. Application Data
(60) Provisional application No. 61/860,934, filed on Aug. 1, 2013.
(60) Provisional application No. 61/861,468, filed on Aug. 2, 2013.

(51) Int. Cl. A23G 9/42; A23G 9/32; A23L 1/303

(52) U.S. Cl. CPC A23G 9/42; A23L 1/303; A23G 9/32; A23V 2002/00
USPC 426/2; 426/565; 426/73

(57) ABSTRACT

A system of delivering a health promoting substance into a human body that includes butter, water, milk protein concentrate, maltitol, erythritol, organic agave inulin, xanthan gum, locust bean gum, and guar gum ingredients at least one flavor ingredient; and a desired health promoting substance. The above ingredients, the flavor ingredient and the desired health promoting substance are formulated as a combined solidified frozen dessert for human consumption.

### RELATED APPLICATIONS

This application claims priority to a U.S. Provisional Patent Application Ser. No. 61/860,934 filed on Aug. 1, 2013 (pending) and U.S. Provisional Patent Application Ser. No. 61/861,468 filed on Aug. 2, 2013 (pending), and incorporated herewith by reference in their entirety.

### BACKGROUND OF THE INVENTION

This application and its disclosure generally relate to the field of delivering healthy substances into a human body.

Various methods and systems of delivering health-promoting substances into a human body have been developed over the years. For example, many vitamins and minerals are administered to people in the form of pills, powders and/or injections. However, a lot of people find these methods of delivery unpalatable.

To eliminate problems associated with prior art methods of delivering and administering health-promoting substances, the present invention discloses a new system of delivering such substances.

### SUMMARY OF THE INVENTION

Generally, it is an object of the present invention to provide a novel delivery method of various health and wellbeing-promoting substances into a human body.

In one general aspect, the invention is a system of delivering a health promoting substance into human body. It includes butter, water, milk protein concentrate, maltitol, erythritol, organic agave inulin, xanthan gum, locust bean gum, and guar gum ingredients; at least one flavor ingredient; and a desired health promoting substance. The above ingredients, the flavor ingredient and the desired health promoting substance are formulated as a combined solidified frozen dessert for human consumption.

In another general aspect, the invention is a metro for delivering a health promoting substance into a human body. The method is accomplished by first combining a desired health promoting substance with butter, water, milk protein concentrate, maltitol, erythritol, organic agave xanthan gum, locust bean gum, and guar gum ingredients in a cooking tank and cooking all combined ingredients together. Thereafter, an enhanced liquid frozen dessert is formed by cooling the cooked combined ingredients in a first cooling step. After the first cooling step is completed, the enhanced liquid frozen dessert is combined with at least one flavor ingredient in a flavor tank to form a flavored enhanced liquid frozen dessert. Thereafter, the flavored enhanced liquid frozen dessert is solidified by cooling it in a second cooling step. Finally, the solidified flavored enhanced frozen dessert is consumed by a human.

In a further general aspect, the invention is a method for delivering a health promoting substance into a human body. The method is accomplished by first combining butter, water, milk protein concentrate, maltitol, erythritol, organic agave inulin, xanthan gum, locust bean gum, and guar gum ingredients in a cooking tank and cooking all of the ingredients together. Thereafter, a liquid frozen dessert is formed by cooling the cooked ingredients in a first cooling step. After the first cooling step is completed, the liquid frozen dessert is combined with at least one flavor ingredient and a desired health promoting substance in a flavor talk so as to form a flavored enhanced liquid frozen dessert. Thereafter, the flavored enhanced liquid frozen dessert is solidified by cooling it in a second cooling step, and is consumed by a human.

The above objects, aspects, advantages and features are of representative embodiments only. It should be understood that they are not to be considered limitations on the invention as defined by the claims. Additional features and advantages of the invention will become apparent in the following description, from the drawings, and from the claims.

### BRIEF DESCRIPTION OF THE DRAWINGS

The invention is illustrated by way of examples which are not a limitation, and the figures of the accompanying drawings in which references denote corresponding parts, and in which:

FIG. 1 is a schematic diagram of the steps of the method of delivering health promoting substances into a human body in accordance with the first embodiment;

FIG. 2 is a schematic diagram of the steps of the method of delivering health promoting substances into a human body in accordance with the second embodiment

FIG. 3 is an illustration of the nutritional composition of the frozen dessert in accordance with one embodiment of the present invention;

FIG. 4 is an illustration of the nutritional composition of the frozen dessert in accordance with a further embodiment of the present invention;

FIG. 5 is an illustration of the nutritional composition of the frozen dessert in accordance with still further embodiment of the present invention;

FIG. 6 is an illustration of the nutritional composition of the frozen dessert in accordance with still further embodiment of the present invention;

FIG. 7 is an exemplary formulation sheet for the frozen dessert incorporating a health-promoting ingredient in accordance with one embodiment of the present invention; and

FIG. 8 is an exemplary formulation sheet for the frozen dessert incorporating a health-promoting ingredient in accordance with another embodiment of the present invention.

### DETAILED DESCRIPTION OF THE INVENTION

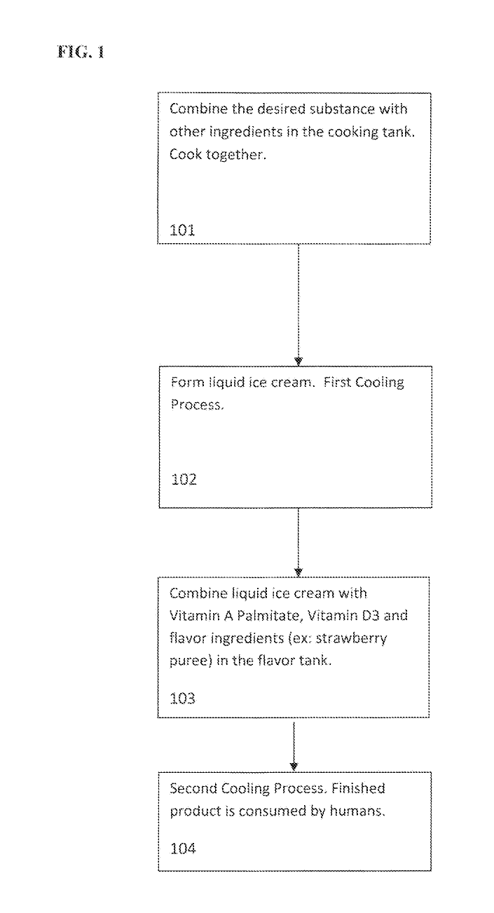

As illustrated in the attached Figures accordance with the preferred embodiment, a health promoting frozen dessert (hereinafter also referred to as “ice cream”) is formulated with desired health promoting ingredients. As shown in FIG. 1, in the first preferred embodiment of the method of delivering a health promoting substance into a human body, the desired health promoting substance (e.g., Garcinia Cambogia) is first combined with Butter, Water, Milk Protein Concentrate, Maltitol, Erythritol, Organic Agave Inulin, Xanthan Gum, Locust Bean Gum, and Guar Gum in a cooking tank, where all of the ingredients are cooked together. The preferred ratio of ingredients is: 1 serving of ice cream to 1 recommended dose of the desired health promoting substance. Step 101. Next, liquid ice cream in combination with the desired substance is formed during the first cooling process. Step 102. After the cooling process of the liquid ice-cream is completed, it is combined with at least one flavor ingredient, for example, strawberry puree, and with other desired ingredients, e.g., Vitamin A Palmitate, and Vitamin D3 in a flavor tank. Step 103. Final the second cooling process completes formation of the ice-cream, which can subsequently be consumed by humans. Step 104.

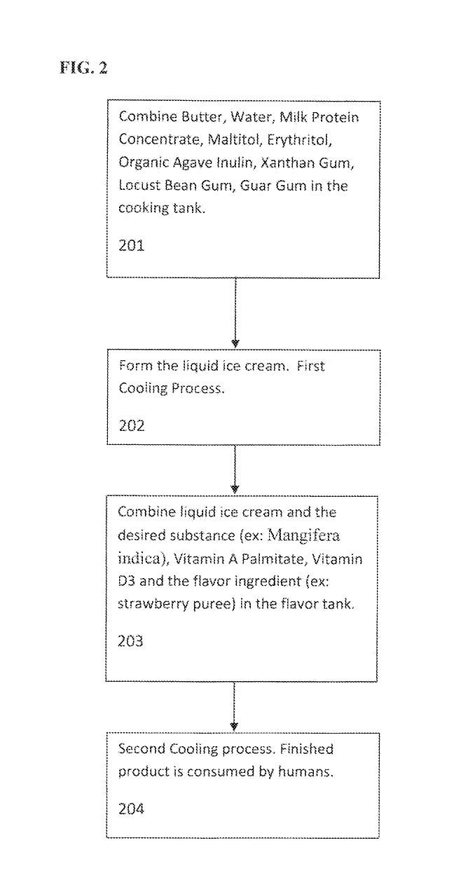

Alternatively, as shown in FIG. 2, in the second preferred embodiment of the method of delivering a health promoting substances into a human body, Butter, Water, Milk Protein Concentrate, Maltitol, Erythritol, Organic Agave Inulin, Xanthan Gum, Locust Bean Gum, and Guar Gum are first combined in a cooking tank, where all of the ingredients are cooked together. Step 201. Next, liquid ice cream is formed during the first cooling process. Step 202. After the cooling process of the liquid ice-cream is completed, it is combined with the desired health promoting substance, e.g., ex: Mangifera indica, at least one flavor ingredient, for example, strawberry puree, and with other desired ingredients, e.g., Vitamin A Palmitate, and Vitamin D3 in a flavor tank. The preferred ratio of ingredients is: 1 serving of ice cream to 1 recommended dose of the desired health promoting substance. Step 203. Finally, the second cooling process completes formation of the ice-cream, which can subsequently be consumed by humans. Step 204.

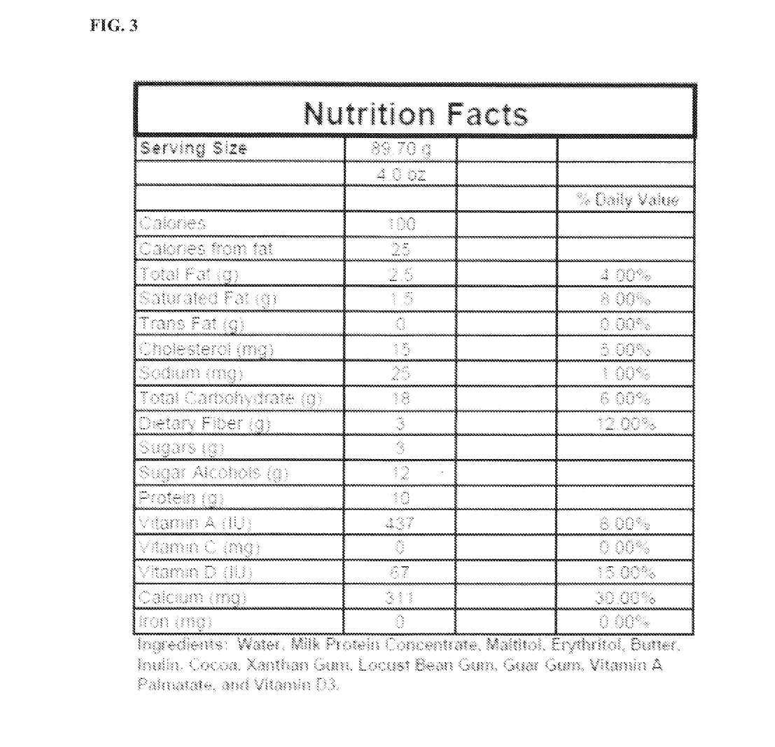

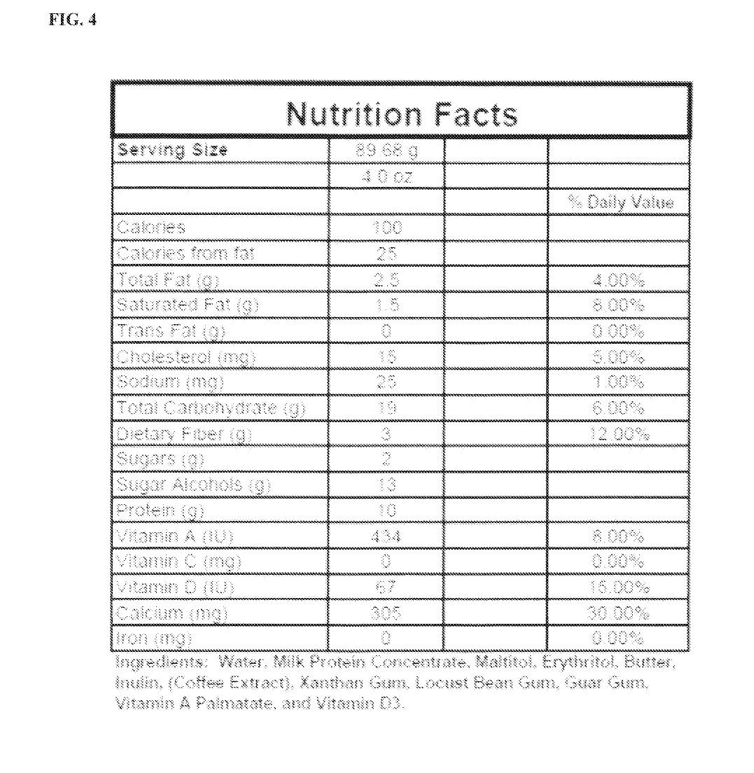

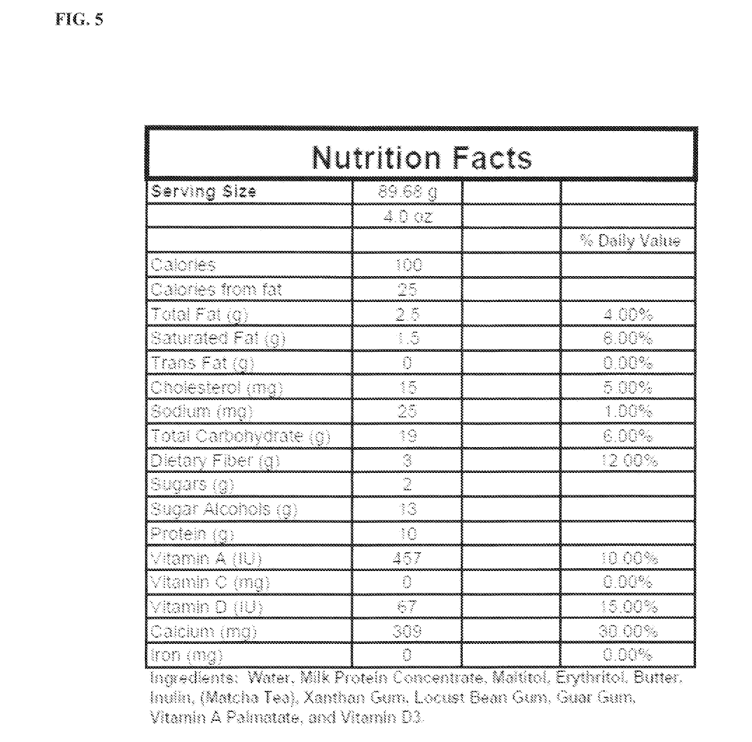

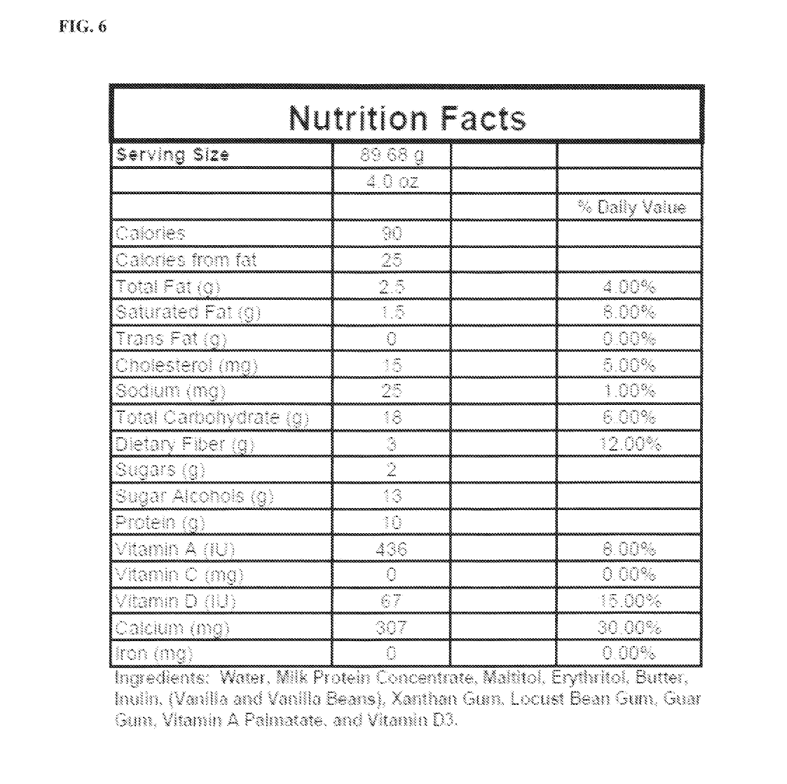

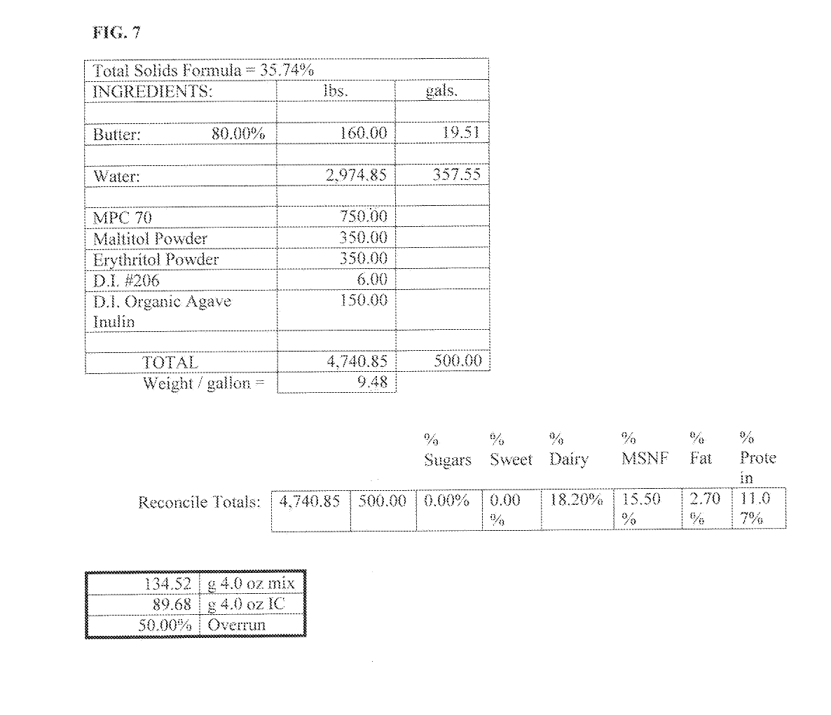

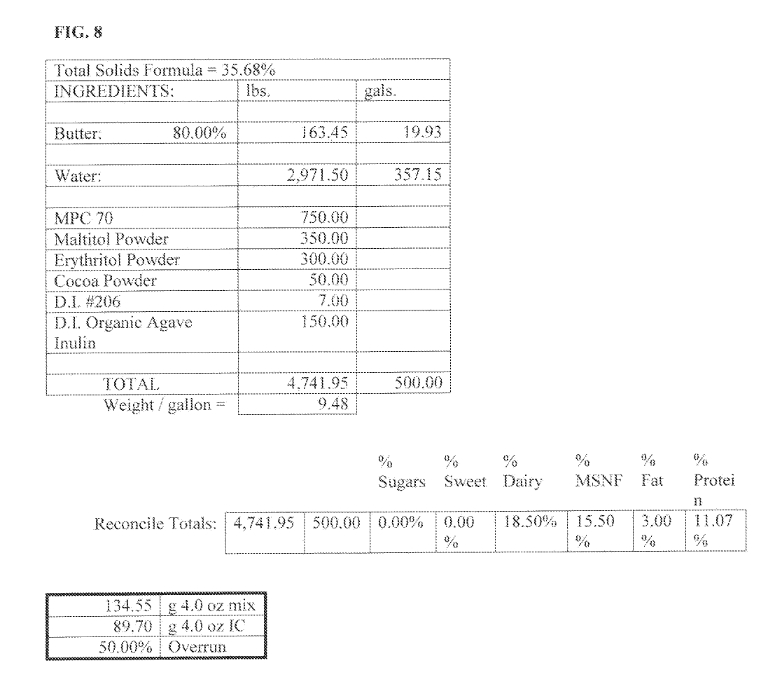

The “delivery system” in the present disclosure is a frozen dessert, for example, ice-cream with any fat content, frozen yogurt, gelato, frozen shakes and smoothies, etc. Specifically, as shown in FIGS. 3-8, the frozen dessert comprises a substance having a desired health benefit, the substance being herbal or botanical in nature. Specifically, a desired health promoting substance (e.g., Damiana flower extract) is combined with Butter, Water, Milk Protein Concentrate, Maltitol, Erythritol, Organic Agave Inulin, Xanthan Gum, Locust Bean Gum, Guar Gum, Vitamin A Palmitate, Vitamin D3, and at least one flavor ingredient, and is formed into a frozen dessert-like product to be consumed by humans.

As illustrated in the attached Figures, in accordance with one preferred embodiment, a low fat protein rich ice cream is made with Butter, Water, Milk Protein Concentrate, Maltitol, Erythritol, Organic Agave Inulin, Xanthan Gum, Locust Bean Gum, Guar Gum, Vitamin A Palmitate, Vitamin D3, along with the flavor ingredient. The frozen dessert is currently available in four flavors: Chi Energy Coffee, Dragon Green Tea, Midnight Chocolate Bliss and Vanilla Bean Dream. The key benefits of this embodiment of the frozen dessert are that it is Vitamins A and D3 fortified, contains organic pre-biotic fiber and milk protein concentrate, and contains no artificial flavors, preservatives, antibiotics, added sugar, gluten, hormones and soy. The preferred vitamin content of this formula is shown below in Table 1.

TABLE 1
PROTEIN FORMULATION (with added vitamins)

| Recalculated Vitamin Values | A | D3 |
|---|---|---|
| Vanilla Bean Dream | 603 IU | 100 IU |
| Chi Energy Coffee | 601 IU | 100 IU |
| Dragon Green Tea | 624 IU | 100 IU |
| Midnight Chocolate Bliss | 600 IU | 100 IU |

In accordance with the preferred embodiment, the Vanilla Bean Dream frozen dessert includes the following ingredients: Butter, Water, Milk Protein Concentrate, Maltitol, Erythritol. Organic Agave Inulin, Xanthan Gum, Locust Bean Gum, Guar Gum, Vanilla Bean Extract, Vanilla Bean Specks, Vitamin A Palmitate, Vitamin D3. in accordance with the preferred embodiment, the Chi Energy Coffee frozen dessert includes the following ingredients: Butter. Water, Milk Protein Concentrate, Maltitol, Erythritol, Organic Agave Inulin, Xanthan Gum, Locust Bean Gum, Guar Gum, Coffee Extract, Vitamin A Palmitate, Vitamin D3. In accordance with the preferred embodiment, the Midnight Chocolate Bliss frozen dessert includes the following ingredients: Butter, Water, Milk Protein Concentrate, Maltitol, Erythritol, Organic Agave Inulin, Xanthan Gum, Locust Bean Gum, Guar Gum, Cocoa Powder (Processed with Alkali), Vitamin A Palmitate, Vitamin D3. In accordance with the preferred embodiment, the Dragon Green Tea frozen dessert includes the following ingredients: Butter, Water, Milk Protein Concentrate, Maltitol, Erythritol, Organic Agave Inulin, Xanthan Gum, Locust Bean Gum, Guar Gum, Green Tea Powder, Vitamin A Palmitate, Vitamin D3. Finally, In accordance with the preferred embodiment, the Strawberry Chill frozen dessert includes the following ingredients: Butter, Water, Milk Protein Concentrate, Maltitol, Erythritol, Organic Agave Inulin, Xanthan Gum, Locust Bean Gum, Guar Gum, Strawberries Puree, Vitamin A Palmitate, Vitamin D3.

In accordance with another preferred embodiment, an energy-promoting low fat ice cream is made with Butter, Water, Milk Protein Concentrate, Maltitol, Erythritol, Organic Agave Inulin, Xanthan Gum, Locust Bean Gum, Guar Gum, Vitamin A Palmitate, Vitamin D3, along with at least one flavor ingredient and an energy blend of Caffeine, Taurine, Inositol, Vitamin B6, and Vitamin B12. This particular the energy busting ice-cream formula has no added sugar, low carbohydrates, low cholesterol and reduced calories. The energy frozen dessert tastes just like regular ice cream and delivers energy without any sugar rush or post-energy-drinks crashes. The product can be consumed as a snack to provide a pre-workout boost or a post-workout pick-me-up. Various flavor ingredients can be utilized with this formula, e.g., acai berry, orange, strawberry, etc.

In accordance with a further preferred embodiment, a libido enhancing low fat ice cream is made with Butter, Water, Milk Protein Concentrate, Maltitol, Erythritol, Organic Agave Inulin, Xanthan Gum, Locust Bean Gum, Guar Gum, Vitamin A Palmitate, Vitamin D3, along with at least one flavor ingredient, Zinc and Damiana flower extract. The key benefit of this formula is the libido boosting effect for both men and women. Damiana (Turnera diffusa) has long been claimed to have a stimulating effect on libido, and its use as an aphrodisiac has continued into modern times. The resulting aphrodisiac frozen dessert tastes just like regular ice cream with a taste similar to figs. The product can be consumed as a snack to increase male functionality and to increase libido in both genders. Various flavor ingredients can be utilized with this formula, e.g., blueberries, acai berry, etc.

In accordance with a further preferred embodiment, a weight-loss promoting low fat ice cream is made with Butter, Water, Milk Protein Concentrate, Maltitol, Erythritol, Organic Agave Inulin, Xanthan Gum, Locust Bean Gum, Guar Gum, Vitamin A Palmitate, Vitamin D3, along with at least one flavor ingredient and Garcinia Cambogia extract that promotes weight loss. Its key benefits: it lowers LDL cholesterol and triglycerides and causes weight loss in humans. Garcinia's inhibition of synthesis of lipids causes glycogen to increase in the liver; the resulting satiety signals sent to the brain causes reduced appetite. The frozen dessert in accordance with this embodiment features no added sugar due to natural sugar replacement, low carbohydrates, and low calories making it desirable for anyone who is trying to lose weight. Another example of weight-loss promoting substance is a Mangifera indica extract, which can be used instead of Garcinia Cambogia or in combination therewith. Various flavor ingredients can be utilized with this formula, e.g., strawberry, mango, etc.

In accordance with a further preferred embodiment, an anti-menstrual cramps and anti-depression frozen dessert is made with Butter, Water, Milk Protein Concentrate, Maltitol, Erythritol, Organic Agave Inulin, Xanthan Gum, Locust Bean Gum, Guar Gum, Vitamin A Palmitate, Vitamin D3, along with at least one flavor ingredient and Kava Kava and/or Bilberry root extract. Kava Kava has been recommended for insomnia, depression and anxiety. Kava Kava works on the central nervous system, and promotes relaxation to those suffering from anxiety or depression. Because of the relaxant properties of Kava Kava, it is very beneficial in treating menstrual cramps as the Kava Kava relaxes the uterus. The frozen dessert in accordance with this embodiment features no added sugar, low carbohydrates, and reduced calories. The product can be consumed as a snack to produce physical and mental relaxation and a feeling of well-being. Various flavor ingredients can be utilized with this formula, e.g., mixed berries, chocolate, coconut, etc.

In accordance with a further preferred embodiment, a low fat ice cream which helps to stabilize and regulate blood sugar is made with Butter, Water, Milk Protein Concentrate, Maltitol, Erythritol, Organic Agave Inulin, Xanthan Gum, Locust Bean Gum, Guar Gum, Vitamin A Palmitate, Vitamin D3, along with at least one flavor ingredient and a number of herbal extracts that are known to stabilize and regulate blood sugar e.g., Fenugreek, Bilberry, Cinnamon, Jambul Berry, and Hibiscus. The key benefit of the frozen dessert, in accordance with this embodiment, is that it delivers a variety of natural supplements to help stabilize and regulate blood sugar. No added sugar, low carbohydrates, and reduced calories make the product desirable for anyone who cannot enjoy frozen desserts due to their medical (diabetic) condition. Various flavor ingredients can be utilized with this formula, e.g., mixed berries, chocolate, green tea, purple tea, coconut, etc.

In accordance with a further preferred embodiment, a low fat ice cream that enhances immune system is made with Butter, Water, Milk Protein Concentrate, Maltitol, Erythritol, Organic Agave Inulin, Xanthan Gum, Locust Bean Gum, Guar Gum, Vitamin A Palmitate, Vitamin D3, along with at least one flavor ingredient and Echinacea flower extract that helps to enhance our immune system. The key benefits of this frozen dessert is that it enhances human immune system and can be used as a remedy for a range of infections and health problems, in particular colds and flu. No added sugar, low carbohydrates, and reduced calories make the product desirable for anyone who is trying to enhance their immune system, looking to take precautionary steps to prevent common cold or flu. Various flavor ingredients can be utilized with this formula, e.g., strawberry, grape, pineapple, etc.

In accordance with a further preferred embodiment, a low fat ice cream that enhances cognitive performance is made with Butter, Water, Milk Protein Concentrate, Maltitol, Erythritol, Organic Agave Inulin, Xanthan Gum, Locust Bean Gum, Guar Gum, Vitamin A Palmitate, Vitamin D3, along with at least one flavor ingredient and Melissa officinalis extract which enhances human cognitive performance. The key benefits of this frozen dessert is that it enhances the cognitive performance and can be used as a remedy to relief stress and for weight management. No added sugar, low carbohydrates, and reduced calories make the product desirable for anyone who is trying to enhance their alertness and concentration. Another example of cognitive performance enhancer is Ginkgo biloba extract. Various flavor ingredients can be utilized with this formula, e.g., green tea, mint, lemon, etc.

The “substances” in the substance delivery system are the ingredients that have the effect described in the product description, i.e., protein, energy complexes, aphrodisiac/libido enhancing plants/herbs, blood regulating/stabilizing plants/herbs, anti-menstrual/anti-depression plants/herbs, immune system enhancing plants/herbs. These could be in the form of but not limited to: powders, extracts, concentrates, oils, elixirs, etc.

In the preceding specification, the invention has been described with reference to specific exemplary embodiments thereof. It will however, be evident that various modifications and changes may be made thereto without departing from the broader spirit and scope of the invention as set forth in the claims that follow. The specification and drawings are accordingly to be regarded in an illustrative manner rather than a restrictive sense.

What is claimed is:

1. A method for delivering a health promoting substance into a human body, the method comprising, the steps of:
combining a desired health promoting substance with butter, water, milk protein concentrate, maltitol, erythritol, organic agave inulin, xanthan gum, locust bean gum, and guar gum ingredients in a cooking tank and cooking all combined ingredients together;
thereafter, forming an enhanced liquid frozen dessert by cooling the cooked combined ingredients in a first cooling step;
after the first cooling step is completed, combining the enhanced liquid frozen dessert with at least one flavor ingredient in a flavor tank to form a flavored enhanced liquid frozen dessert;
thereafter, solidifying the flavored enhanced liquid frozen dessert by cooling it in a second cooling step; and
eating the solidified flavored enhanced frozen dessert by a human.

2. The method according to claim 1, wherein the desired health promoting substance comprises Vitamin A Palmitate and Vitamin D3.

3. The method according to claim 1, wherein the desired health promoting substance comprises at least one of a Damiana flower extract, a Garcinia Cambogia extract, a Mangifera Indica extract, a Fenugreek extract, a Bilberry extract, a Cinnamon extract, a Jambul Berry extract, a Hibiscus extract, a Kava Kava extract, a Bilberry root extract, an Echinacea flower extract, a Melissa Officinalis extract, and a Ginkgo Biloba extract.

4. method for delivering health promoting substance into a human body, the method comprising the steps of:
combining butter, water, milk protein concentrate, maltitol, erythritol, organic agave inulin, xanthan gum, locust bean gum, and guar gum ingredients in a cooking tank and cooking all of the ingredients together;
thereafter, forming a liquid frozen dessert by cooling the cooked ingredients in a first cooling step;
after the first cooling step is completed, combining the liquid frozen dessert with at least one flavor ingredient and a desired health promoting substance in a flavor tank so as to form a flavored enhanced liquid frozen dessert;
thereafter, solidifying the flavored enhanced liquid frozen dessert by cooling it in a second cooling step; and
eating the tie solidified flavored enhanced frozen dessert by a human.

5. The method according to claim 4, wherein the desired health promoting substance comprises Vitamin A Palmitate and Vitamin D3.

6. method according to claim 4, wherein the desired health promoting substance comprises at least one of a Damiana flower extract, a Garcinia Cambogia extract, a Mangifera Indica extract, a Fenugreek extract, a Bilberry extract, a Cinnamon extract, a Jambul Berry extract, a Hibiscus extract, a Kava Kava extract, a Bilberry root extract, an Echinacea flower extract, a Melissa Officinalis extract, and a Ginkgo Biloba extract.

7. A system of delivering a health promoting substance into a human body comprising:
butter, water, milk protein concentrate, maltitol, erythritol, organic agave inulin, xanthan gum, locust bean gum, and guar gum ingredients;
at least one flavor ingredient; and
a desired health promoting substance,
wherein said ingredients, said at least one flavor ingredient and said desired health promoting substance are formulated as a combined solidified frozen dessert for human consumption.

8. The system according to claim 7, wherein the desired health promoting substance comprises Vitamin A Palmitate and Vitamin D3.

9. The system according to claim 7, wherein the desired health promoting substance comprises at least one of Damiana flower extract, a Garcinia Cambogia extract, a Mangifera Indica extract, a Fenugreek extract, a Bilberry extract, a Cinnamon extract, a Jambul Berry extract, a Hibiscus extract, a Kava Kava extract, a Bilberry root extract, an Echinacea flower extract, a Melissa Officinalis extract, and a Ginkgo Biloba extract.
